(19) United States
(12) Patent Application Publication
(10) Pub. No.: US 2015/0007148 A1
(43) Pub. Date: Jan. 1, 2015

(54) Identifying Test Cases Based on Changed Test Code

(71) Applicant: International Business Machines Corporation, Armonk, NY (US)

(72) Inventors: Timothy S. Bartley, Worongary (AU); Gavin G. Bray, Robina (AU); Elizabeth M. Hughes, Currumbin Valley (AU); Kalvinder P. Singh, Miami (AU)

(21) Appl. No.: 14/487,497

(22) Filed: Sep. 16, 2014

Related U.S. Application Data
(63) Continuation of application No. 13/779,804, filed on Feb. 28, 2013.

(51) Int. Cl. G06F 11/36; G06F 9/44

(52) U.S. Cl. CPC G06F 11/3688; G06F 8/70
USPC 717/131

(57) ABSTRACT

An approach is provided to identify test cases based on changed test code. In the approach, test cases are compared to a current test environment that includes an instrumented software program that results in matching test cases. Matching test cases are selected based on a detection of one or more substantive changes to the current test environment. The current test environment is tested using the selected test cases. In an alternate approach, the current environment is tested with multiple test cases and code coverage metrics are retained. After the initial testing, modification of the software program results in comparing of the modification to the retained code coverage metrics whereupon a set of the test cases are selected and used to re-test the software program.

### TECHNICAL FIELD

The present disclosure relates to an approach that time needed to test software code after changes have been made to the software.

### BACKGROUND OF THE INVENTION

Software engineering best practice is that software should be thoroughly tested prior to release. Automating software testing is often the most cost effective approach and can involve thousands of test cases where a test case consists of a combination of test code, test data and test configuration required to execute the test. Typically, each test case tests some aspect of the software under test. When the code changes, identifying the corresponding subset of test cases to re-execute is a difficult task. For instance, if a comment has changed, or a rare error condition has been addressed, then the test may not need to be re-executed. If there are many tests in a single file, and only one test has changed, automatically selecting that test to re-execute is difficult. Existing solutions to selecting a subset of test cases include: manually selecting test cases, running all test cases, and using a makefile. Manually selecting the subset of test cases requires the tester to manually identify the test cases that test the specific software under test and is time consuming for the tester, and prone to human error. While re-executing all the test cases guarantees the subset of test cases that have changed are re-executed, this approach used vast time and/or resources which may result in the approach being infeasible. In addition, feedback to the development team is delayed due to the time required. Finally, using a makefile with the correct dependency listing lists the test cases that have changed. However, with the makefile approach, changes to the test case code that does not affect the test case run will be marked for rerun with similar challenges found in the approach of re-executing all of the tests.

### SUMMARY

An approach is provided to identify test cases based on changed test code. In the approach, test cases are compared to a current test environment that includes an instrumented software program that results in matching test cases. Matching test cases are selected based on a detection of one or more substantive changes to the current test environment. The current test environment is tested using the selected test cases. In an alternate approach, the current environment is tested with multiple test cases and code coverage metrics are retained. After the initial testing, modification of the software program results in comparing of the modification to the retained code coverage metrics whereupon a set of the test cases are selected and used to re-test the software program.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in identifying test cases based on changed test code;

FIG. 4 is a depiction of a flowchart showing the logic used in the testing process that identifies test cases based on changed test code; and

FIG. 5 is a depiction of a flowchart showing the logic used in selecting the next test case to use in testing a design-under-test.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

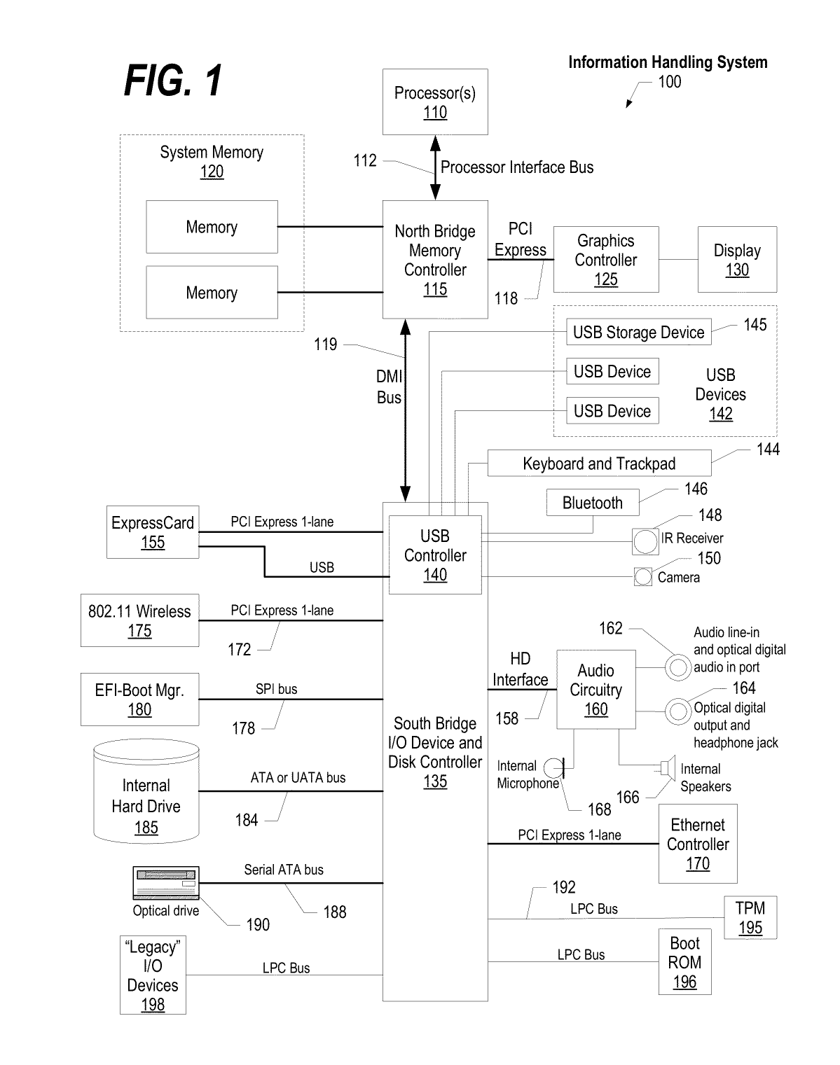

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

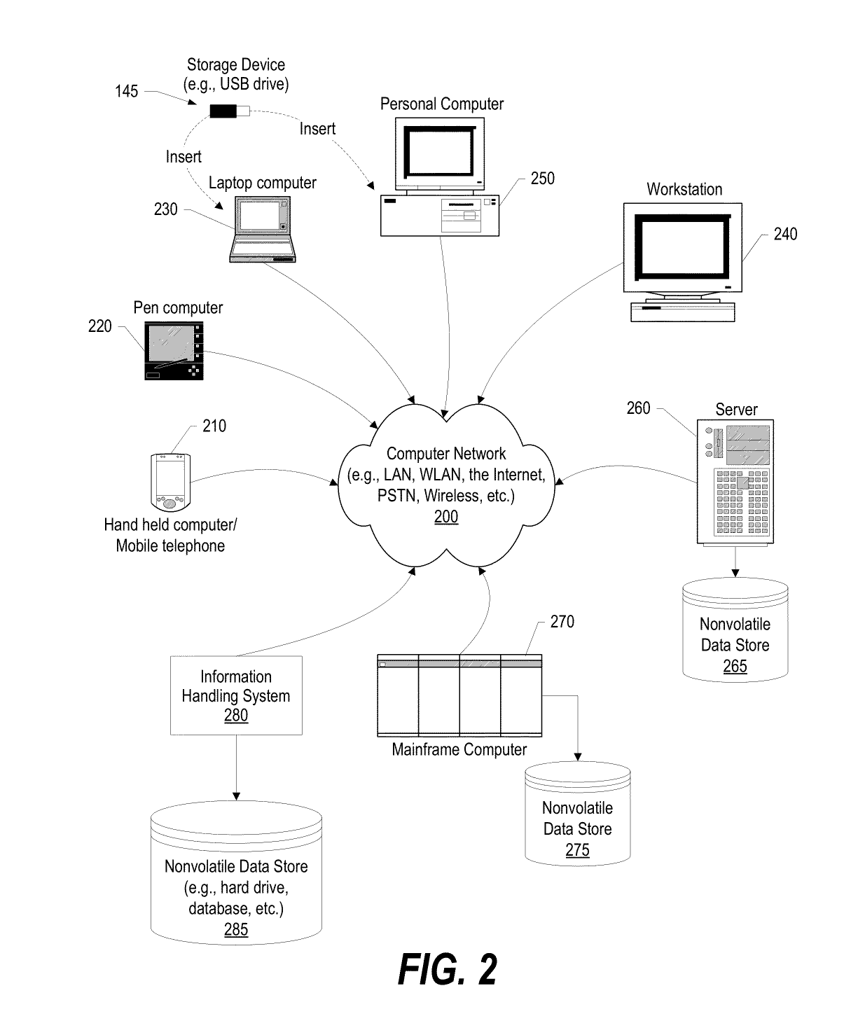

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

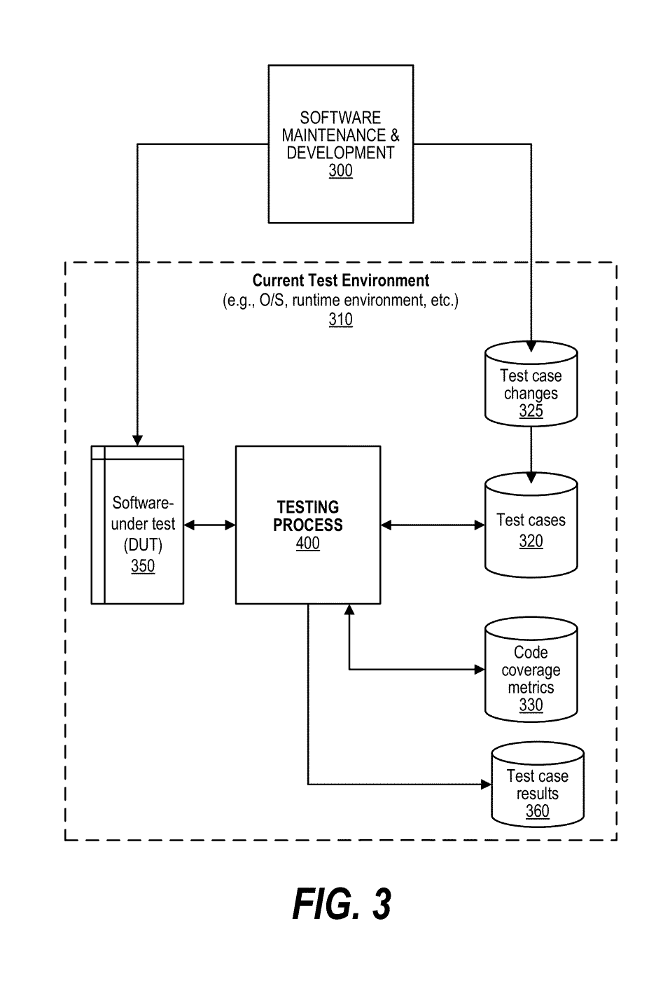

FIGS. 3-5 depict an approach that can be executed on an information handling system and computer network as shown in FIGS. 1-2. An approach is provided for identifying test cases based on changed test code. In this approach, the test code is an instrumented software program that is used to test the production code. The software program is enabled for code coverage metrics. The software program can be is written using best practices, where environmental differences in test cases might be hidden in the underlying libraries. Libraries and classes can be categorized as including environmental specific test code. This environmental specific test code can be specified either manually or automatically via code coverage metrics. The environment, such as the operating system version, the input data, the software installed, etc., can be discovered automatically. The test case run is categorized under different environments, with the characteristics of an environment including attributes such as the computer hardware type; the operating system type and version, and the software type and version. Test cases are executed against the production code using an instrumented version of the software program. For each test case used in testing, the process obtains and retains test code coverage metrics. The test code coverage metrics are associated with the test case that was run and the environment data corresponding to the current environment (operating system, etc.) that was in use when the software program was tested.

When code in the software program is modified by a tester, the corresponding test cases are identified and marked for execution. If the modified code only affects particular environments, then only the test cases associated with that environment are executed. Even though a test case may rely upon a certain modified component, it may not need to be re-executed if the modified test code path in that modified component does not affect the test case. The steps used to obtain information about the test code path that was followed in each of the test execution include (a) enabling the environment for code coverage of the software program, (b) running the test cases in the enabled environment, (c) retrieving the code coverage from the instrumented software code, (d) mapping the code coverage to the environment, and (e) storing information about the test case and the code coverage in a set of code coverage metrics. As indicated above, the software code is instrumented so that when it is executed, data pertaining to the test code path that was followed is retrieved. When running the test case, information about the environment that the test was run on is retrieved as well as other environmental information that the test case will rely upon. Environmental information may also include any inputs that the test case may need. The test code path that was followed during a test execution is obtained after a successful test run of the instrumented software code. The test case execution is mapped to a environment. The environment can include information such as the operating system version, the number of machines used, the data that is inputted into the test case, etc. The information about the test run and the test code covered is stored.

When code is modified the following steps are performed. The test code change has been checked into source control and is, at this point, detected as a modification. The test infrastructure detects the modification in the source code. After the source code change has been detected, the test infrastructure retrieves the lines, methods, and test cases that have changed. The source code change data is compared with the code coverage and with the environments on which the software program was executed. The changes in the source test code are checked with the test code coverage data to determine if there is an intersection and, if an intersection is found, to discover which test cases were affected. Because the test code coverage data is mapped to the environment, the process also determines which environments the tests should be executed. Once the process identifies the test cases that need to be executed, the identified test cases are marked to be run along with the environments on which the tests should be run.

When a new environment is added, the test infrastructure automatically detects the new environment and schedules a test run with test code coverage enabled. A new test environment can be based on a new operating system version, new input data, new software installed, etc. When a new environment is added for a test case or test cases, the test infrastructure detects the change and initiates a re-execution of the test coverage data. The test cases that are affected by the new environment will need to be run with the test code coverage environment enabled. Further details regarding the approach outlined above is set forth in FIGS. 3-5 and corresponding test below.

FIG. 3 is a component diagram showing the various components used in identifying test cases based on changed test code. Software maintenance and development (300) include both software developers that make changes to a software program (350) as well as testers that develop test cases (320) and make changes to the test cases (test case change 325).

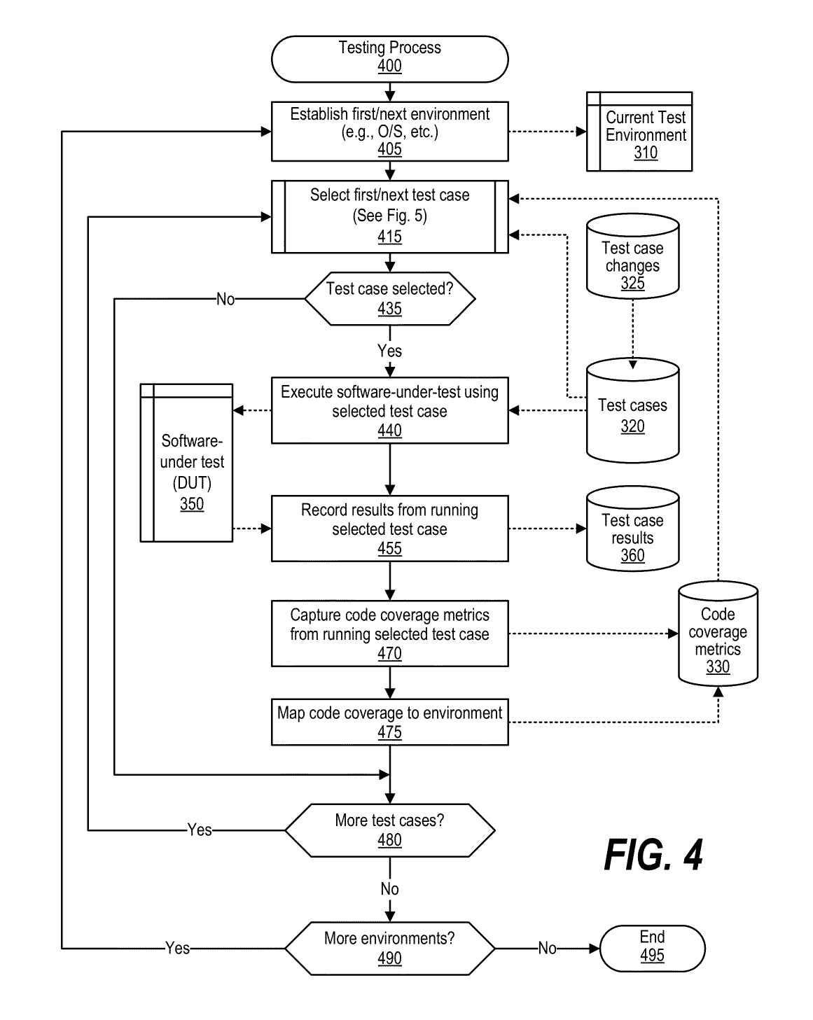

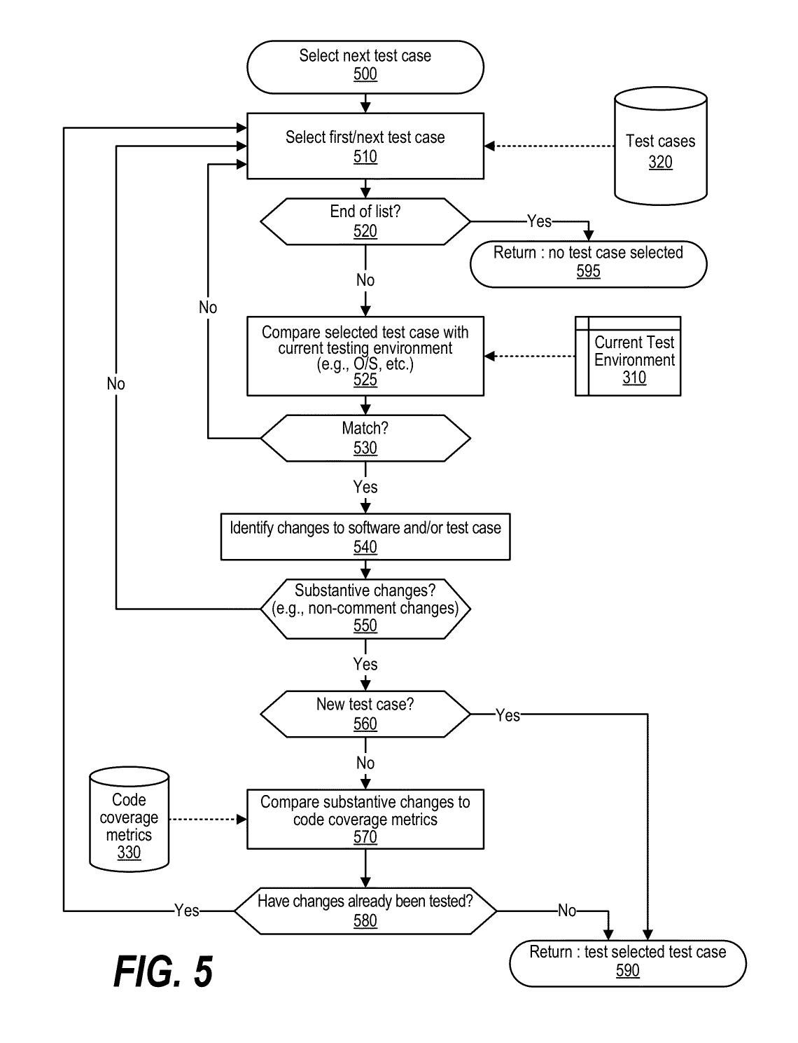

Testing process, described in more detail in the flowcharts shown in FIGS. 4 and 5, test software program 350 using test cases 320. In addition, the testing process reads and updates code coverage metrics (data store 330) to identify test cases that should be run based on the current test environment (310), the changes made to software program 350, the significance of the change made to the software, and whether coverage of the change has already been provided by one of the test cases. When a test case is executed on the software program, the code coverage metrics (data store 330) are updated to indicate that the software program (test code path) has been tested along with environmental data (e.g., operating system version in use, data inputted to the software program, etc.) that was used in the testing. The updated code coverage metrics stored in data store 330 is then used by subsequent invocations of the testing process in order to identify test cases that should be run on changed software code, rather than testing the software program using test cases that have already been used. In addition, the testing process returns test case results (data store 360) which are evaluated by the testers and other software developers to ascertain whether the software program executed correctly or is experiencing errors.

FIG. 4 is a depiction of a flowchart showing the logic used in the testing process that identifies test cases based on changed test code. Processing commences at 400 whereupon, at step 405, the first test environment (current test environment) is established. The test environment includes environmental factors such as the software program being tested, the operating system type and version used to execute the software program, and the data inputted to the software program for testing. Current test environment 310 is established as a result of step 405.

At predefined process 415, the first test case used to test the software program is selected (see FIG. 5 and corresponding text for processing details). As described in further detail in FIG. 5, test cases are selected based on detected modifications to the software program under test, a comparison of the detected modification to code coverage metrics that have previously been gathered when testing the software program, and a determination of whether the change to the software program is a substantive change necessitating testing or an insubstantial change (e.g., comments, etc.) that does not necessitate the running of a test case. A decision is made as to whether predefined process 415 selected a test case to use in testing the software program (decision 435). If no test case was selected (e.g., the software program had insubstantial changes made, the code coverage metrics revealed that the area of the software program has already been tested, etc.), then decision 435 branches to the “no” branch bypassing the remaining steps. On the other hand, if a test case was selected by predefined process 415, then decision 435 branches to the “yes” branch to process the selected test case.

At step 440, software program 350 is executed and tested in the current test environment using the selected test case which is retrieved from test case data store 320. At step 455, the testing process receives test results from the instrumented software program and these results are stored in test case results data store 360 for further evaluation and analysis by testers and software developers to ascertain whether software program 350 is operating correctly. At step 470, the process updates code coverage metrics in data store 330 to indicate that the tested test cases were previously tested. The storing includes storing the test code path and environment data, such as the operating system type and version used, the machines used, and the data inputted to the software program. At step 475, the code coverage data captured in step 470 is mapped to the current test environment and this mapping information is also stored in code coverage metrics data store 330.

A decision is made as to whether there are additional test cases that should be evaluated for possible selection (decision 480). If there are more test cases to be evaluated, then decision 480 branches to the “yes” branch which loops back to predefined process which evaluates the test cases and determines whether to select a test case for use in testing software program 350. This looping continues until there are no more test cases to evaluate, at which point decision 480 branches to the “no” branch. A decision is made as to whether there are additional environments that the tester wishes to establish and use in testing the software (decision 490). For example, if the software program is used on several different operating system versions, then after establishing a current test environment based on the a first operating system version, a subsequent current test environment can be established based on a second operating system version and the software can be retested by selecting test cases, as outlined above, for use in testing the software program running on the second operating system. If more environments need to be established and used to test the software program, then decision 490 branches to the “yes” branch which loops back to step 405 to establish the next test environment and evaluate the test cases to identify those test cases that should be used to test the software program given the newly established test environment. This looping continues until all of the desired testing environments have been established and used to test the software program, at which point decision 490 branches to the “no” branch and test processing ends at 495.

FIG. 5 is a depiction of a flowchart showing the logic used in selecting the next test case to use in testing a design-under-test. This routine is called from FIG. 4 (predefined process 415) in order to evaluate test cases and select the next test case to use to test the software. Returning to FIG. 5, processing commences at 500 when the routine is called, at which point the routine selects the first test case from test case data store 320 for evaluation (step 510). A loop is established so that the test cases are processed until there are no more test cases to evaluate (decision 520). When the end of the list of test cases has not been reached, then decision 520 branches to the “no” branch whereupon, at step 525, the selected test case is compared to the current test environment.

A decision is made (decision 530) as to whether the selected test case matches the current test environment (e.g., operating system version being used, code path being tested, possible data input constraints, etc.). If the selected test case does not match the current test environment, then decision 530 branches to the “no” branch which loops back to select and compare the next test case with the current test environment. This looping continues until either there are no more test cases to evaluate (at which point decision 520 branches to the “yes” branch whereupon at 595 processing returns to the calling routine without selecting a test case), or until a selected test case matches the current test environment, at which point decision 530 branches to the “yes” branch to further evaluate the selected test case.

At step 540, changes to the test case and the software program are identified. A decision is made as to whether substantive changes (e.g., non-comment changes, etc.) were identified to either the software program or to the test case (decision 550). If only non-substantive (e.g., comments, etc.) changes were identified, then decision 550 branches to the “no” branch which loops back to continue selecting and evaluating other test cases. On the other hand, if substantive changes were identified, then decision 550 branches to the “yes” branch for further processing.

A decision is made as to whether the test case is a new test case that has not yet been used to test the software program (decision 560). If the test case is a new test case, then decision 560 branches to the “yes” branch whereupon processing returns the selected test case to the calling routine (see FIG. 4) to test the software program using the selected test case. On the other hand, if the test case is not a new test case, then decision 560 branches to the “no” branch whereupon, at step 570, the selected test case and current test environment data is compared to code coverage metrics, retrieved from data store 330, that were gathered when the software program was previously tested. A decision is made, based on the comparison, as to whether the changes (code path, inputted data, other environment data, etc.) have already been tested either by the selected test case or by another test case that provided similar (overlapping) code path coverage (decision 580). If the comparison at step 570 reveals that the changes have already been tested, then decision 580 branches to the “yes” branch which loops back to continue selecting and evaluating other test cases. On the other hand, the comparison at step 570 reveals that the changes have not yet been tested, then decision 580 branches to the “no” branch whereupon processing returns the selected test case to the calling routine (see FIG. 4) to test the software program using the selected test case.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of identifying test cases based on changed test code, the method, implemented by an information handling system, comprising:
comparing, using at least one of a plurality of processors, a plurality of test cases to a current test environment, wherein the comparing results in a set of matching test cases that match the current test environment;
selecting, using at least one of the plurality of processors, one or more of the matching test cases based on a detection of one or more substantive changes made to the current test environment; and
testing, using at least one of the plurality of processors, the current test environment using the one or more selected test cases.

2. The method of claim 1 wherein the current test environment includes an operating system that is executing an instrumented software program that is being tested.

3. The method of claim 1 further comprising:
retrieving a set of code coverage metrics that indicate a plurality of previously tested code paths previously tested in the current test environment;
based on the retrieved set of code coverage metrics:
testing the current test environment using the selected test cases that correspond to untested changes; and
refraining from testing the current test environment using the selected test cases that correspond to previously tested changes.

4. The method of claim 3 further comprising:
after the testing, updating the set of code coverage metrics to indicate that the tested test cases were previously tested in the current test environment.

5. The method of claim 4 further comprising:
prior to the comparing:
testing the current test environment using each of the plurality of test cases.

6. The method of claim 5 wherein the current test environment includes an operating system that is executing a software program that is being tested, wherein the method further comprises:
updating the set of code coverage metrics after testing each of the plurality of test cases to indicate that each of the plurality of test cases were previously tested, wherein the updating further includes associating the updated test code coverage metrics with the current test environment.

7. The method of claim 6 further comprising:
obtaining a test code path from the software program, wherein the software program is instrumented;
mapping the execution of the instrumented software program to a set of environmental test data, wherein the environmental test data includes an operating system version and a data that was input to the instrumented software program; and
storing the test code path and the environment data in the test code coverage metrics.

8. A method of identifying test cases based on changed test code, the method, implemented by an information handling system, comprising:
initially testing a current environment that includes an operating system executing an instrumented software program, wherein the initial testing tests the instrumented software program using a plurality of test cases;
in response to the initial testing, gathering code coverage metrics from the instrumented software program, wherein the code coverage metrics include a test code path from and a set of environment data;
after the initial testing:
detecting a modification of the instrumented software program;
comparing the detected modification to the gathered code coverage metrics;
based on the comparison, selecting a set of one or more test cases from the plurality of test cases; and
re-testing the instrumented software program using the selected test cases.

9. The method of claim 8 further comprising:
gathering additional code coverage metrics corresponding to the testing of the instrumented software program using the selected test cases; and
updating the code coverage metrics based on the additional code coverage metrics.

10. The method of claim 8 further comprising:
identifying whether the detected modification is a substantial modification, wherein the selecting refrains from including test cases corresponding to insubstantial modifications in the set of test cases.

11. The method of claim 8 further comprising:
identifying that the set of test cases are untested against the detected modification, wherein the selecting includes untested test cases in the set of test cases and refrains from including previously tested test cases in the set of test cases; and
after the re-testing, marking each of the set of test cases as being previously tested against the detected modification.
